(19) United States
(12) Patent Application Publication
(10) Pub. No.: US 2015/0137671 A1
(43) Pub. Date: May 21, 2015

(54) PORTABLE COMPACT COCKTAIL STATION

(71) Applicant: MATTHEW CHRISTIAN PEAKE, MIDLOTHIAN, VA (US)

(72) Inventor: MATTHEW CHRISTIAN PEAKE, MIDLOTHIAN, VA (US)

(21) Appl. No.: 14/508,283

(22) Filed: Oct. 7, 2014

Related U.S. Application Data
(60) Provisional application No. 61/904,567, filed on Nov. 15, 2013.

(51) Int. Cl. A47J 31/00; A47J 31/46

(52) U.S. Cl. CPC A47J 31/005; A47J 31/46
USPC 312/140.2

(57) ABSTRACT

A portable compact cocktail station which combines the essential functions of a full restaurant bar in a convenient tabletop unit which requires no disassembly, collapsing, or folding before transportation or storage. In use, this cocktail station provides a compact working area for an individual drink preparer, as well as storage for the most commonly used alcohol varieties and accessories.

### CROSS-REFERENCE TO RELATED APPLICATIONS

This application claims the benefit of PPA Ser. No. 61/904,567, filed Nov. 15, 2013 by the present inventor, which is incorporated by reference.

### BACKGROUND

1. Technical Field

The present invention relates to a hand portable compact cocktail preparation station.

2. Prior Art

The following is a tabulation of some prior art that presently appears relevant:

U.S. Patents

| Pat. No. | Issue Date | Patentee |
|---|---|---|
| USD92270 S | May 15, 1934 | Fred Schmid |
| U.S. Pat. No. 1,985,412 A | Jan. 29, 1934 | Robert W. Jackson |
| U.S. Pat. No. 4,681,244 A | Apr. 30, 1986 | John D. Geddie |
| U.S. Pat. No. 1,913,387 A | Feb. 12, 1932 | Malcolm Hayward |
| U.S. Pat. No. 4,842,350 A | Apr. 18, 1988 | James Collings |
| U.S. Pat. No. 5,915,602 A | Mar. 31, 1997 | Andrew Nelson |
| U.S. Pat. No. 4,437,714 A | Dec. 21, 1981 | Gordon Struck |

Existing bars that claim to be portable are very complex and cumbersome and require assembly/disassembly, collapsing, folding, carting, all of which make them difficult to be taken to everyday activities and events where individuals come together to celebrate or relax.

### SUMMARY OF A FIRST EMBODIMENT

The present invention relates to the provision of a portable compact cocktail station in the form of a lightweight tabletop unit which can be carried like a crate, but which provides the major functions of a full restaurant bar including but not limited to: speed rail, mixing tray and spillover bin, cutting board, garnish bin, ice bin, cup holder, and storage area.

### BRIEF DESCRIPTION OF THE DRAWINGS

FIG. 1 shows an isometric view of a first embodiment.

FIG. 2 shows a front-view perspective of a first embodiment.

FIG. 3 shows a left side-view perspective of a first embodiment.

FIG. 4 shows a right side-view perspective of a first embodiment.

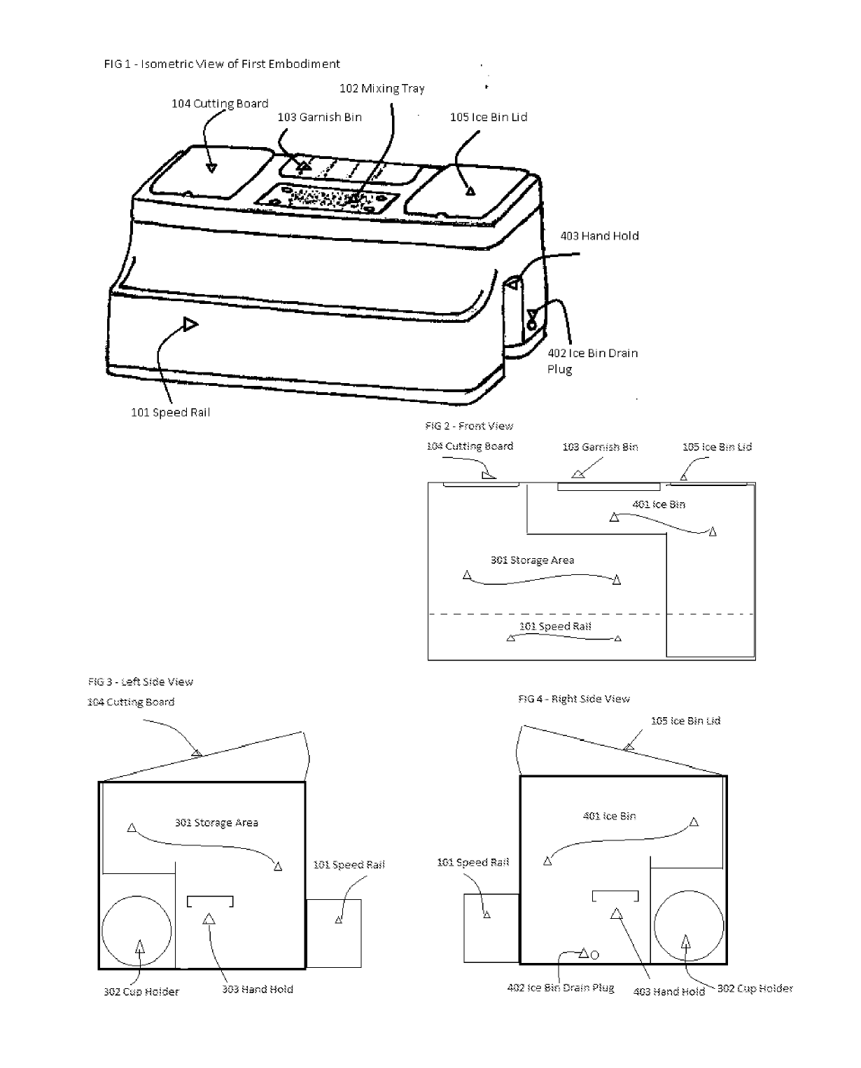

### DETAILED DESCRIPTION—FIGS. 1, 2, 3, 4—FIRST EMBODIMENT

FIG. 1 shows an isometric view of a first embodiment. As shown in FIG. 1, the top of the compact portable cocktail station includes, but is not limited to: 101 Speed Rail, 102 Mixing Tray, 103 Garnish Bin, 104 Cutting Board, and 105 Ice Bin Lid.

FIG. 2 shows a front view perspective of the internal compartments of a first embodiment including 101 Speed Rail, 103 Garnish Bin, 104 Cutting Board, 105 Ice Bin Lid, 301 Storage Area, and 401 Ice Bin.

FIG. 3 shows a left side-view perspective of a first embodiment including the side-view of 101 Speed Rail, 104 Cutting Board, 301 Storage Area, 302 Cup Holder, and 303 Hand Hold.

FIG. 4 shows a right side-view perspective of a first embodiment including side-view of 101 Speed Rail, 105 Ice Bin Lid, 401 Ice Bin, 402 Ice Bin Drain Plug, and 403 Hand Hold.

### Operation—FIGS. 1, 2, 3, 4

The portable compact cocktail station is comprised of a top surface, base, two sidewalls, front panel, back panel, and 101 Speed Rail. It is portable by means of 303 and 403 Hand Holds in the sidewalls such that the unit can be moved or stored in either its loaded or unloaded condition.

The 101 Speed Rail trough holds up to seven 750 ml bottles. The 102 Mixing Tray is where drinks are prepared and consists of a perforated surface through which spilled liquid flows into a spill bin. The entire spill bin latches into place and can be removed for cleaning. The 103 Garnish Bin consists of segregated compartments for holding cocktail garnishes such as olives, cherries, and lime or lemon slices. This 103 Garnish Bin is removable and washable and has a lid to keep the garnishes fresh and protected from insects. The 104 Cutting Board serves multiple purposes. As a cutting board, it is used to prepare garnishes such as sliced lime or lemon. The 104 Cutting Board is hinged and serves as a lid to the storage area beneath. The storage area is intended to hold bartender accessories such as towel, shaker, mixing rod, strainer, and other bar tools. The 105 Ice Bin Lid is a hinged lid providing access to an insulated ice storage bin beneath. The 401 Ice Bin is double-lined and condensation-free and continues under the 103 Garnish Bin thus providing indirect chilling to the garnishes. The 402 Ice Bin Drain Plug enables melted ice to easily be drained from the cocktail station. The 302 Cup Holder is a spring loaded cup dispenser.

I presently contemplate the use of injection molded plastic for the manufacture of the first embodiment allowing for customized manufacture in certain colors and bearing certain logos. I contemplate a second embodiment constructed of wood. The second embodiment would differ from the first embodiment in that the cup tunnel may be replaced with a side drawer providing storage of standard size soda cans or mixing juices for use as “mixers” (non-alcoholic constituents) in cocktails.

### Conclusions, Ramifications, And Scope

The Portable Compact Cocktail Station is a lightweight, convenient, portable unit that can be carried by one person and combines the essential functions of a full restaurant bar in a convenient tabletop unit which requires no disassembly, collapsing, or folding before transportation or storage. In use, this cocktail station provides a compact working area for an individual drink preparer, as well as storage for the most commonly used alcohol varieties and accessories.

The simplicity of the subject cocktail station allows manufacturing in many materials, including injection molded plastic, wood, and stainless steel. This makes the invention compatible with many applications and locations or environments where the consumption of mixed drinks would bring joviality and mirth to the individuals in attendance. The essential cocktail station unit can be integrated into more complex cabinets and bar units for the home, office, or catering facility, greatly exceeding the functionality currently available to individual cocktail enthusiasts.

I claim:

1. A cocktail preparation unit of predetermined size to be portable by hand by a human being comprising:
a. a plurality of vertical walls, a base, and a top surface, together defining a cabinet having a plurality of inner spaces
b. said top surface providing for preparation of cocktail beverages
c. a speed rail trough whereby bottles are conveniently held
d. said speed rail being attached to one side of said cocktail preparation unit

2. the cocktail preparation unit of claim 1 further comprising an ice bin

3. the ice bin of claim 2 further comprising an ice storage area, lid, and drainage plug whereby ice is stored and melted ice may be conveniently drained

4. the ice bin of claim 2 wherein said ice bin is double-lined and insulated

5. the cocktail preparation unit of claim 1 further comprising a cup dispenser

6. the cup dispenser of claim 5 further comprising a tunnel and a spring loaded dispenser whereby cups are conveniently held and dispensed

7. the cocktail preparation unit of claim 1 further comprising a dry storage area

8. the top surface of claim 1 further comprising a mixing tray and spill bin

9. the mixing tray and spill bin of claim 8 wherein cocktails are prepared on a mixing tray with perforated surface through which spilled liquid flows into a spill bin which latches into place and can be removed for cleaning

10. the top surface of claim 1 further comprising a cutting board

11. the cutting board of claim 10 whereby garnishes may be cut and wherein said cutting board is hinged and thus providing access to the storage area beneath

12. the top surface of claim 1 further comprising a garnish tray

13. the garnish tray of claim 12 wherein said garnish tray consists of segregated compartments for individual garnishes and lid whereby garnishes are kept fresh
